(19) United States
(12) Patent Application Publication
(10) Pub. No.: US 2020/0100626 A1
(43) Pub. Date: Apr. 2, 2020

(54) CUP AND FLUID DISPENSER APPARATUS AND METHOD OF USE

(71) Applicant: Craig Gentry, Dahlonega, GA (US)

(72) Inventor: Craig Gentry, Dahlonega, GA (US)

(21) Appl. No.: 16/149,520

(22) Filed: Oct. 2, 2018

(51) Int. Cl. A47K 5/12; B67D 1/00; A47F 1/08

(52) U.S. Cl. CPC A47K 5/1217; B67D 3/0029; A47F 1/085; B67D 1/0004

(57) ABSTRACT

A fluid and cup dispensing apparatus includes a body having an interior cavity to hold cups and a fluid bottle; a door pivotally attached to the body, the door having an opening into a shelf to hold a single cup; a cup container secured within the interior cavity to hold the cups; a reservoir to removably receive the fluid bottle such that the fluid bottle is inverted and open, the reservoir having a tube extending to a position above the shelf; a control system with a power source to activate cup and fluid dispensing; and a button to activate the control system; the control system activates opening of the cup container to drop the single cup; and the control system activates fluid flow through the tube.

### BACKGROUND

### 1. Field of the Invention

The present invention relates generally to the use of cups with a fluid, such as a mouth wash, and more specifically, to a cup and fluid dispenser apparatus that provides for convenient and quick means to automatically dispense and fill a cup for use.

### 2. Description of Related Art

Cup and fluid systems are well known in the art and are effective means to use a fluid, such as mouthwash. For example, FIG. 1 depicts a conventional system 101 having mouthwash 103 and a cup 105. During use, the user typically removes the cup 105 from a stack and proceeds to pour the mouthwash 103 therein to rinse their mouth.

One of the problems commonly associated with system 101 is limited use. For example, this process takes time and further requires opening the fluid container, and pouring the mouthwash, which can result in overuse of the mouthwash.

Accordingly, although great strides have been made, many shortcomings remain. It is therefore an object of the present invention to provide an apparatus to store cups and a fluid, such as mouthwash, and dispense the two together, thereby providing the user with a consistent amount of mouthwash to use.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified front view of a common fluid and cup system;

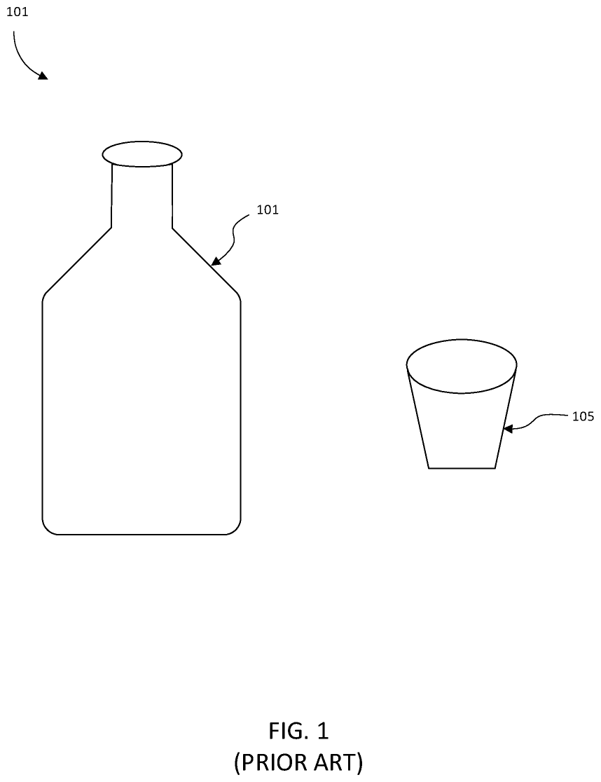

FIG. 2 is a front closed view of a fluid and cup dispensing apparatus in accordance with a preferred embodiment of the present application;

FIG. 3 is a front open view of the apparatus of FIG. 2;

FIG. 4 is a simplified schematic of the control system of FIG. 2; and

FIG. 5 is a flowchart of the method of use of the apparatus of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional fluid and cup systems. Specifically, the present invention provides an apparatus that dispenses both cups and fluid at the push of a button, thereby providing for a convenient and automated means to use a consistent amount of fluid. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

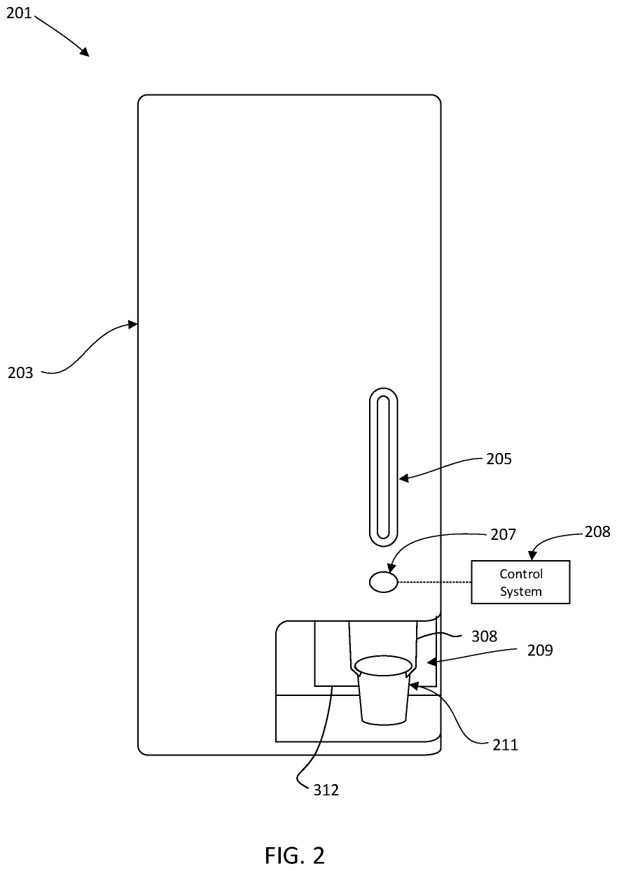

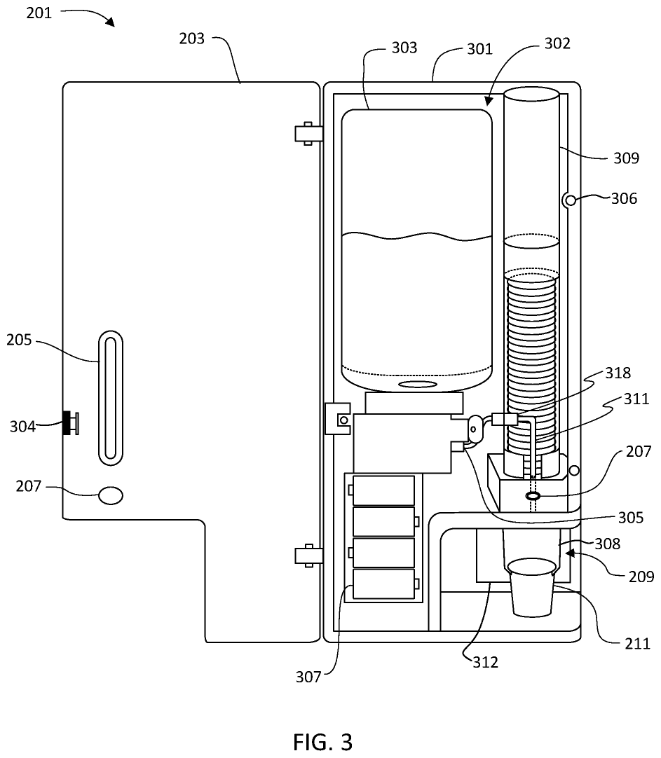

Referring now to the drawings wherein like reference characters identify corresponding or similar elements throughout the several views, FIGS. 2 and 3 depict front views of a fluid and cup dispensing apparatus in accordance with a preferred embodiment of the present application. It will be appreciated that apparatus 201 overcomes one or more of the above-listed problems commonly associated with conventional systems.

In the contemplated embodiment, apparatus 201 includes a body 301 with a door 203 pivotally attached thereto to provide access to an interior cavity 302. In the preferred embodiment, the body is approximately 4 inches deep from front to back, which complies with the Americans with Disabilities Act Standards for Accessible design. The door 203 can include a window 205 configured to provide visibility into the interior cavity 302, particularly to determine when a cup container 309 needs to be filled. Further, the door 203 can include a lock 304 configured to lock the door closed. Prior to locking the door closed, a magnet 306 can hold the door closed for ease of locking. It should be appreciated that the lock prevents the contents of the device from being tampered with.

Apparatus 201 further includes a shelf 209 within the interior cavity 302 and accessible through the door 203 when the door is in a closed position. It should be appreciated that the shelf 209 provides for an area for a cup to drop during use. In some embodiments, a cradle 308 is configured to catch the cup as it drops. Further, in some embodiments, a sensor 312 is positioned to determine the presence of a cup. The sensor provides for information to prevent the liquid from dispensing in the absence of a cup. During use, even if the button is pressed, the liquid will not dispense if a cup is not present.

As shown, the interior cavity 302 holds a plurality of cups via a cup container 309 secured therein. In addition, the interior cavity 302 holds a fluid bottle 303 in an inverted position via a reservoir 305, wherein the reservoir is connected to a position above a single cup 211 via a tube 311. In the preferred embodiment, a check valve 318 is configured to prevent leaks from the tube when not in use, the valve being controlled via the control system.

Apparatus 201 further includes a control system 208 which runs from a power source 307 and is in communication with a button 207 accessible via an opening 306 in the door 203. During use, the button 207 activates control system 208 to dispense a single cup 211 and activate the flowing of fluid through tube 311 and into the cup. It should be appreciated that the control system 208 is pre-programed to first dispense the single cup, and then activate a pre-determined amount of fluid flow.

It should be appreciated that one of the unique features believed characteristic of the present application is the single button activation of the cup and fluid dispensing.

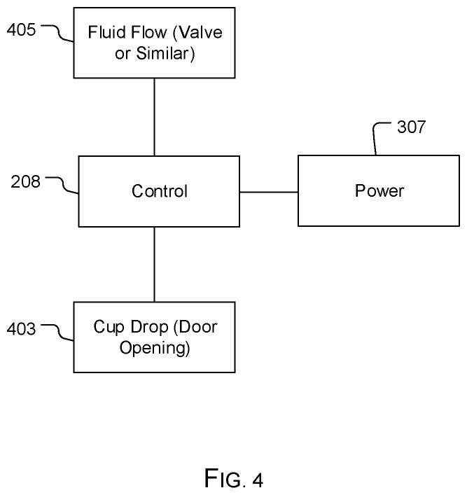

In FIG. 4 a simplified schematic of a control system 208 is shown. It should be appreciated that the control system 208 can include various components, the components including the power source 307, as well as communication with a valve 405 or similar component that provides a means for fluid control through the tube. The control system 208 is further configured to drop a cup via a door 403 or similar configuration.

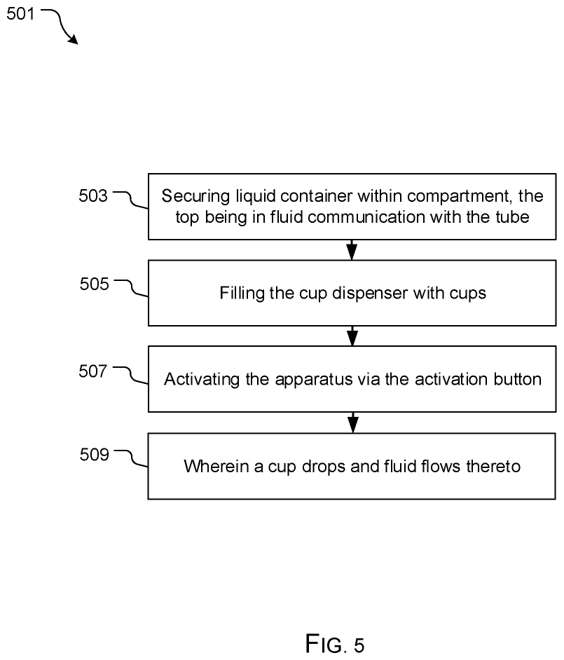

In FIG. 5, a flowchart 501 depicts a method of use of apparatus 201. During use, the user first fills the cup container and adds the fluid bottle, such as mouthwash, to the interior cavity, as shown with boxes 503, 505. The user then proceeds to activate the apparatus via the activation button which is in communication with the control system, as shown with box 507. The single cup drops and the fluid flows therein, as shown with box 509.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A fluid and cup dispensing apparatus, comprising:
a body having an interior cavity configured to hold a plurality of cups and a fluid bottle;
a door pivotally attached to the body, the door having an opening into a shelf configured to hold a single cup;
a cup container secured within the interior cavity and configured to hold the plurality of cups;
a reservoir configured to removably receive the fluid bottle such that the fluid bottle is inverted and open;
a fluid conduit in fluid communication with the fluid reservoir;
a check valve in fluid communication with the fluid conduit;
a cradle configured to hold a single cup of the plurality of cups in a stationary position, the fluid conduit is positioned to direct fluid from the reservoir to the single cup, the cup container is positioned above of the cradle;
a control system with a power source and configured to activate cup and fluid dispensing; and
a button configured to activate the control system, the button is positioned in direct line with the fluid conduit;
wherein the control system activates opening of the cup container to drop the single cup; and
wherein the control system activates fluid flow through the tube.

2. The apparatus of claim 1, wherein the door includes a window into the interior cavity to provide visibility of the cup container.

3. The apparatus of claim 1, wherein the power source is a plurality of removable batteries.

4-7. (canceled)

8. The apparatus of claim 1, further comprising:
a lock configured to secure the door in a closed position.

9. A method of dispensing fluid and cups, the method comprising:
providing the apparatus of claim 1;
filling the cup container with the plurality of cups;
inserting the fluid bottle in the inverted position to engage with the reservoir; and
activating dispensing of a single cup and fluid flow into the cup via the control system and button.
